(19) United States
(12) Patent Application Publication
(10) Pub. No.: US 2025/0340266 A1
(43) Pub. Date: Nov. 6, 2025

(54) METHOD AND SYSTEM FOR ADJUSTING POWER ASSIST OF ELECTRIC ASSISTED BICYCLE

(71) Applicants: Acer Incorporated, New Taipei City (TW); Acer Gadget Inc., Taipei City (TW)

(72) Inventors: Yung-Yuan Cheng, New Taipei City (TW); Chih-Yuan Chang, Taipei City (TW); Jun-An Lin, Taipei City (TW); Yueh-Yarng Tsai, New Taipei City (TW); Yun-Hsuan Chan, New Taipei City (TW); Chih-Wei Tu, New Taipei City (TW); Ke-Han Pan, New Taipei City (TW)

(73) Assignees: Acer Incorporated, New Taipei City (TW); Acer Gadget Inc., Taipei City (TW)

(21) Appl. No.: 19/199,402

(22) Filed: May 6, 2025

(30) Foreign Application Priority Data
May 6, 2024 (TW) 113116708

(51) Int. Cl. B62M 6/45; G07C 5/04

(52) U.S. Cl. CPC B62M 6/45; G07C 5/04

(57) ABSTRACT

Disclosed are a method and a system for adjusting power assist of an electric assisted bicycle. The method includes the following steps. A riding record of the electric assisted bicycle traveling along a route according to a first power-assisted control parameter is collected. The first power-assisted control parameter is configured to control motor output of the electric assisted bicycle. During a period of the electric assisted bicycle traveling along the route, a control command issued by a rider is recorded. The riding record is analyzed to obtain riding summary data of multiple route sections. The first power-assisted control parameter is updated to a second power-assisted control parameter, so that the rider rides the electric assisted bicycle to travel another route according to the updated second power-assisted control parameter.

### CROSS-REFERENCE TO RELATED APPLICATION

This application claims the priority benefit of Taiwan application serial no. 113116708, filed on May 6, 2024. The entirety of the above-mentioned patent application is hereby incorporated by reference herein and made a part of this specification.

### BACKGROUND

### Technical Field

The disclosure relates to an electric assisted bicycle, and in particular to a method and a system for adjusting power assist of an electric assisted bicycle.

### Description of Related Art

For different purposes such as environmental protection, health, leisure, or economy, bicycle riding has become increasingly popular in modern society. Generally, when riding a traditional bicycle, the rider drives the bicycle forward by pedaling. In contrast, electric assisted bicycles are becoming more and more popular because electric assisted bicycles are powered by electricity and are less strenuous to ride. When riding the electric assisted bicycle, the rider manually adjusts the power assist of the electric assisted bicycle according to a personal ability, a riding habit, and road conditions, so that the electric assisted bicycle may provide the power assist to the rider in the actual need. However, manually adjusting the power assist level every time is quite inconvenient for the rider. In addition, the process of the rider manually adjusting the power assist easily distracts the rider and increases the risk.

### SUMMARY

The disclosure provides a method and a system for adjusting power assist of an electric assisted bicycle, which can solve the aforementioned technical problems.

An embodiment of the disclosure provides a method for adjusting a power assist of an electric assisted bicycle, which includes the following steps. A riding record of the electric assisted bicycle traveling along a route is collected according to a first power-assisted control parameter. The first power-assisted control parameter is configured to control a motor output of the electric assisted bicycle. A control command issued by a rider is recorded during a period of the electric assisted bicycle traveling along the route. The riding record is analyzed to obtain riding summary data of multiple route sections. The first power-assisted control parameter is updated to a second power-assisted control parameter according to the control command and the riding summary data of the route sections, so that the rider rides the electric assisted bicycle to travel another route according to the updated second power-assisted control parameter.

An embodiment of the disclosure provides a system for adjusting a power assist of an electric assisted bicycle, which includes a storage device and a processor. The processor is coupled to the storage device and configured to perform the following operation. A riding record of the electric assisted bicycle traveling along a route is collected according to a first power-assisted control parameter. The first power-assisted control parameter is configured to control a motor output of the electric assisted bicycle. A control command issued by a rider is recorded during a period of the electric assisted bicycle traveling along the route. The riding record is analyzed to obtain riding summary data of multiple route sections. The first power-assisted control parameter is updated to a second power-assisted control parameter according to the control command and the riding summary data of the route sections, so that the rider rides the electric assisted bicycle to travel another route according to the updated second power-assisted control parameter.

In order to make the aforementioned features and advantages of the disclosure comprehensible, embodiments accompanied with drawings are described in detail below.

### BRIEF DESCRIPTION OF THE DRAWINGS

FIG. 1 is a schematic diagram of a system for adjusting power assist of an electric assisted bicycle according to an embodiment of the disclosure.

FIG. 2 is a block diagram of a system for adjusting power assist of an electric assisted bicycle according to an embodiment of the disclosure.

FIG. 3 is a flowchart of a method for adjusting power assist of an electric assisted bicycle according to an embodiment of the disclosure.

FIG. 4 is a schematic diagram of a method for adjusting power assist of an electric assisted bicycle according to an embodiment of the disclosure.

FIG. 5 is a schematic diagram of multiple route sections according to an embodiment of the disclosure.

FIG. 6 is a schematic diagram of determining a riding event according to an embodiment of the disclosure.

FIG. 7 is a flowchart of updating a first power-assisted control parameter to a second power-assisted control parameter according to an embodiment of the disclosure.

FIG. 8 is a flowchart of a method for adjusting power assist of an electric assisted bicycle according to an embodiment of the disclosure.

### DESCRIPTION OF THE EMBODIMENTS

A portion of the embodiments of the disclosure is described in detail hereinafter with reference to figures. In the following, the same reference numerals in different figures should be considered to represent the same or similar elements. These embodiments are only a portion of the disclosure and do not disclose all of the possible implementations of the disclosure. More precisely, these embodiments are only examples in the claims of the disclosure.

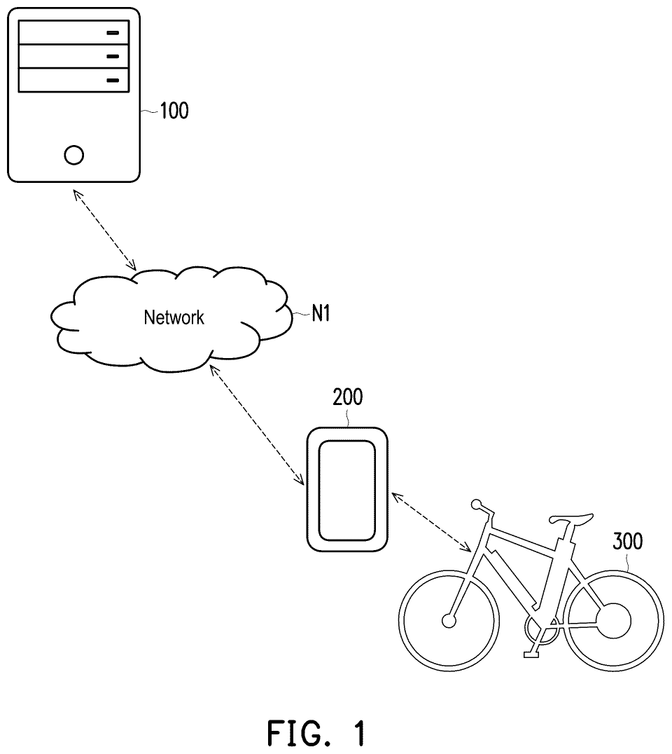

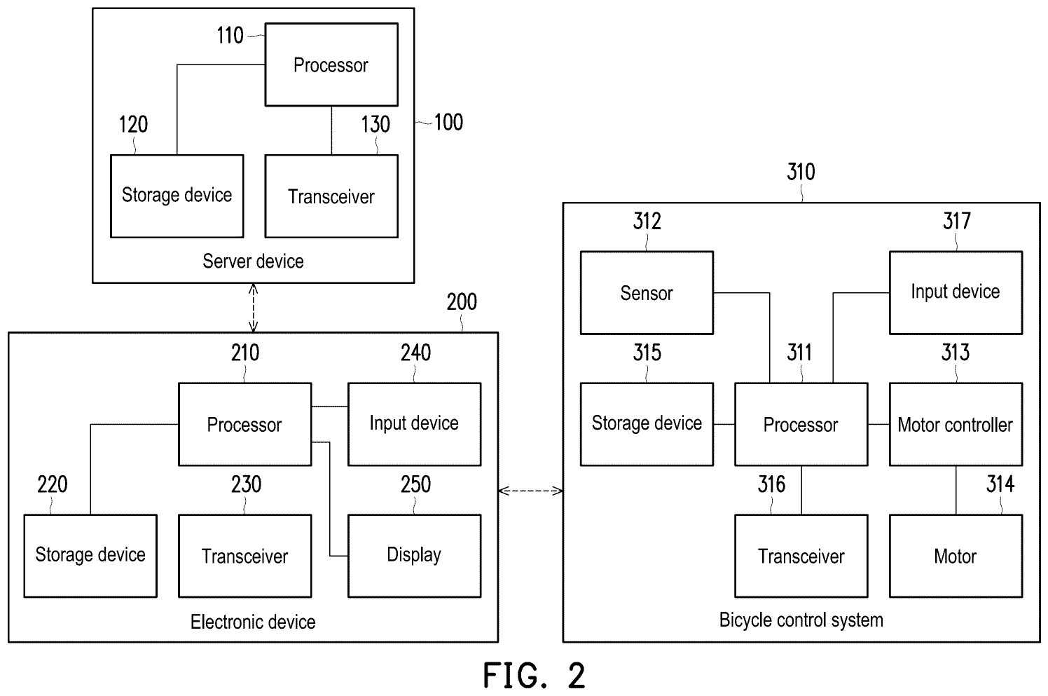

Please refer to FIG. 1 and FIG. 2. FIG. 1 is a schematic diagram of a system for adjusting power assist of an electric assisted bicycle according to an embodiment of the disclosure. FIG. 2 is a block diagram of a system for adjusting power assist of an electric assisted bicycle according to an embodiment of the disclosure.

A system 10 for adjusting the power assist of the electric assisted bicycle includes a server device 100, an electronic device 200, and an electric assisted bicycle 300. The server device 100 may be connected to the electronic device 200 via a network N1. The electronic device 200 and a bicycle control system 310 of the electric assisted bicycle 300 may establish a wired/wireless communication connection. For example, the electronic device 200 and the bicycle control system 310 of the electric assisted bicycle 300 may establish a Bluetooth connection or a universal serial bus (USB) connection.

The network N1 may include any combination of public and/or private networks, regional networks and/or wide area networks, and so on. In addition, the network N1 may utilize one or more wired and/or wireless communication technologies. In some embodiments, the network N1 may include, for example, a cellular or other mobile networks, a wireless local area network (WLAN), a wireless wide area network (WWAN), and/or an internet network. An example of the network N1 include a long term evolution (LTE) wireless network, a fifth generation (5G) wireless network (also known as a new radio (NR) wireless network or a 5G NR wireless network), a Wi-Fi WLAN, and an internet network.

The server device 100 is an electronic device having a data storage capability, a computing capability, and a networking capability. The server device 100 may include (but is not limited to) a storage device 120, a transceiver 130, and a processor 110. The storage device 120 is configured to store data, commands, software modules, or programs. The processor 110 may access and execute commands, software modules, or programs in the storage device 120. The transceiver 130 is configured to connect to the network N1 to receive and send data. In some embodiments, the server device 100 may be implemented by one or multiple cloud servers of a cloud computing platform. The cloud computing platform may be any cloud computing platform known in the art, such as Amazon Web Services (AWS), Microsoft Azure, GOOGLE CLOUD, or other cloud computing platforms.

The electronic device 200 is, for example, a smartphone, a smart watch, a wearable electronic device, or other user terminal devices. The electronic device 200 may include (but is not limited to) a processor 210, a storage device 220, a transceiver 230, an input device 240, and a display 250. The storage device 220 is configured to store data, commands, software modules, or programs. The processor 210 may access and execute commands, software modules, or programs in the storage device 220. The transceiver 230 may include a transceiver circuit configured to connect to the network N1 to receive and send data and a transceiver circuit configured to connect to the bicycle control system 310. The input device 240 is, for example, a touch screen or a button, and is configured to receive the issued control command. The display 250 is configured to display a user interface of an application.

The electric assisted bicycle 300 is a vehicle that combines human pedaling and electric assistance. When the rider steps on the pedals of the electric assisted bicycle 300, the electric assisted bicycle 300 may provide the power assist to the rider, so that the rider is able to drive the tires of the electric assisted bicycle 300 to rotate with less effort. The electric assisted bicycle 300 includes the bicycle control system 310. The bicycle control system 310 includes a processor 311, a sensor 312, a motor controller 313, a motor 314, a storage device 315, a transceiver 316, and an input device 317. In addition, the electric assisted bicycle 300 also includes a rechargeable battery (not shown), such as a lithium battery, which provides power to the motor 314.

The sensor 312 may include a pedaling sensor, which is configured to sense the pedaling state of the rider pedaling. For example, the pedaling sensor may include a cadence sensor and a torque sensor. The torque sensor may be configured to sense the pedaling force of the rider. The cadence sensor may be configured to sense the pedaling frequency of the rider. In addition, the sensor 312 may include a speed sensor configured to sense the riding speed of the electric assisted bicycle 300. In addition, the sensor 312 may include a slope sensor configured to sense slope data of a riding route of the electric assisted bicycle 300.

The motor controller 313 may be configured to control the start, stop, rotation speed, steering, and other operations of the motor 314. The motor 314 may provide the power assist to the rider, so that the rider is able to step on the pedals of the electric assisted bicycle 300 with less effort. Specifically, the motor 314 is configured to provide the driving torque required for the electric assisted bicycle 300 to move forward to drive at least one wheel of the electric assisted bicycle 300. The storage device 315 is configured to store data, commands, software modules, or programs. The processor 311 may access and execute commands, software modules, or programs in the storage device 315, and the processor 311 may monitor and control the operating state of the entire electric assisted bicycle 300. The transceiver 316 is configured to connect to the electronic device 200 to receive and send data.

The input device 317, such as a touch screen or a button, is disposed on the electric assisted bicycle 300, and is configured to receive a control command issued by the rider. For example, the input device 317 may include a power-assisted adjustment button, and the rider is able to manually adjust the amount of power assist by pressing the power-assisted adjustment button.

The storage devices 120, 220, and 315 are, for example, solid state memories, hard disks, read-only memories (ROMs), flash memories, other similar devices, or combinations thereof. The processors 110, 210, and 311 are, for example, central processing units (CPUs), application processors, other general-purpose or specific-purpose programmable microprocessors, digital signal processors (DSPs), programmable controllers, application specific integrated circuits (ASICs), programmable logic devices (PLDs), other similar devices, or combinations thereof, which may respectively execute commands, software modules, or programs in the storage devices 120, 220, and 315.

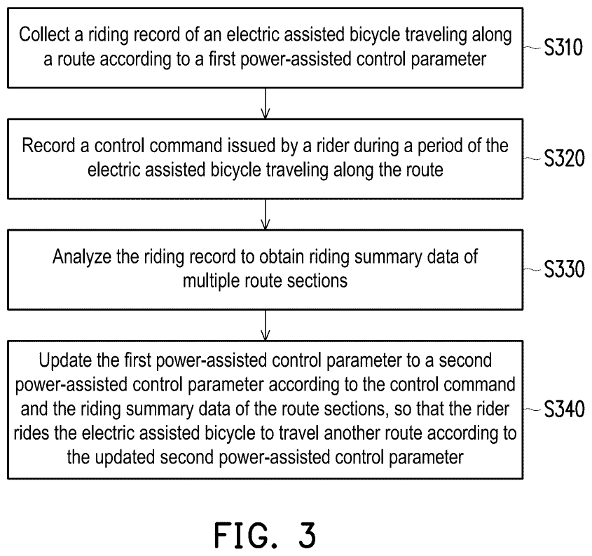

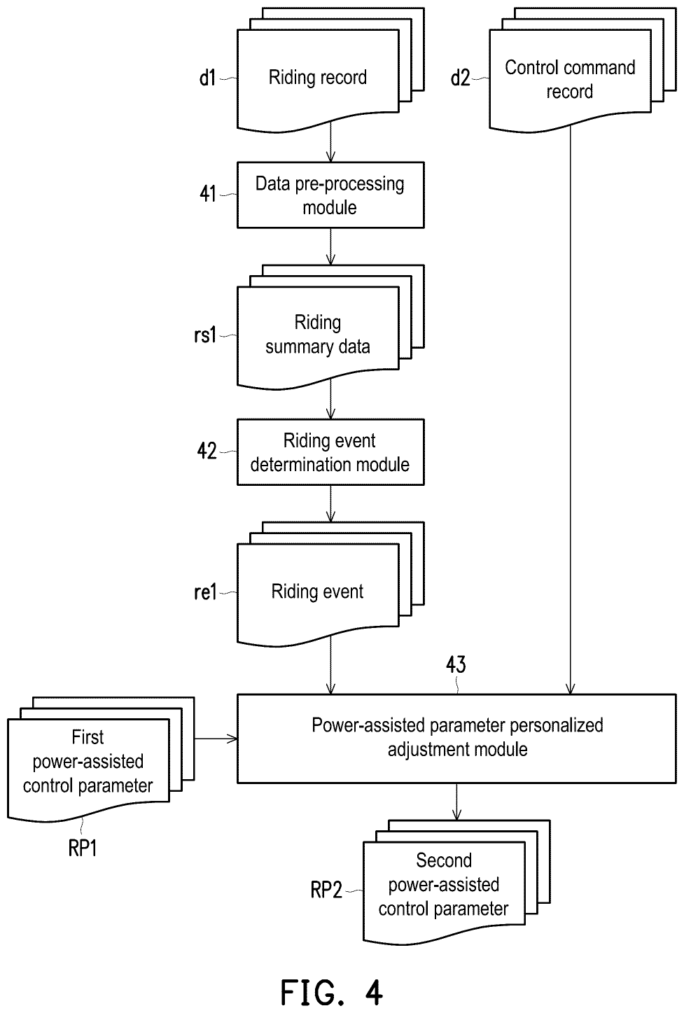

FIG. 3 is a flowchart of a method for adjusting power assist of an electric assisted bicycle according to an embodiment of the disclosure. A description of the steps of the method for adjusting the power assist of the electric assisted bicycle according to this embodiment with reference to the elements in FIG. 1 and FIG. 2. In addition, in order to clearly illustrate the concept of the disclosure, FIG. 4 incorporated to facilitate comprehension of the following description, which is a schematic diagram of a method for adjusting power assist of an electric assisted bicycle according to an embodiment of the disclosure.

In step S310, the server device 100 collects a riding record d1 of the electric assisted bicycle 300 traveling along the route according to a first power-assisted control parameter RP1. This first power-assisted control parameter RP1 is configured to control the motor output of the electric assisted bicycle 300. Specifically, the storage device 315 of the electric assisted bicycle 300 may record the first power-assisted control parameter RP1 provided by the server device 100. When the rider rides the electric assisted bicycle 300 to travel along the route, the processor 311 and the motor controller 313 of the electric assisted bicycle 300 controls the output of the motor 314 according to the first power-assisted control parameter RP1.

In some embodiments, the first power-assisted control parameter RP1 may include a max assist power (MAP), an assist ratio percentage (ARP), or a motor control parameter. The MAP is a parameter configured to limit the max assisting force of the motor 314. The ARP represents a ratio between the power assist provided by the motor 314 and human pedaling. The motor control parameter may include a motor ramp up curve of the motor 314, a motor torque, or a proportional-integral-derivative (PID) parameter. In addition, during a riding process, the processor 311 and the motor controller 313 control the output of the motor 314 according to real-time sensing data of the sensor 312 (such as real-time cadence, real-time pedaling force, real-time riding speed, or a current slope) and the first power-assisted control parameter RP1.

In addition, when the rider rides the electric assisted bicycle 300 to travel along the route, the processor 311 may continuously record the riding record d1, and uploads the riding record d1 to the server device 100 by the electronic device 200. In some embodiments, the processor 311 may obtain the riding record d1 related to the pedaling state by the sensor 312. Alternatively, in some embodiments, the processor 311 may obtain the riding record d1 related to the motor output state from the motor controller 313. Alternatively, in some embodiments, a GPS positioning device disposed on the electronic device 200 or the electric assisted bicycle 300 may obtain the riding record d1 related to a GPS position.

In some embodiments, the riding record d1 includes multiple riding parameters corresponding to multiple sampling time points. For example, the processor 311 may automatically record the riding record d1 including the riding parameters every second, and upload the riding parameters corresponding to the sampling time points to the server device 100. In other words, it is assumed that the rider rides the electric assisted bicycle 300 for 10 minutes and the data recording period is 1 second, then the processor 311 may record 600 riding records d1 corresponding to 600 sampling time points. The riding record d1 may include the riding parameters corresponding to the sampling time points.

In some embodiments, the riding parameters of the riding record d1 may include accumulated mileage, riding speed, pedaling frequency, pedaling torque, pedaling power, a motor current, a motor voltage, battery power, recording time, a max power ratio percentage, the ARP, the GPS position, and so on. The max power ratio percentage is a ratio between the MAP and the max power of the motor. When the electric assisted bicycle 300 travels along the route, the sensor 312 of the electric assisted bicycle 300 is configured to detect the riding parameters. That is, the riding parameters of the riding record d1 may be obtained by the sensor 312, the motor controller 313, and the GPS positioning device. For example, Table 1 is an example of the riding parameters corresponding to one sampling time point (for example, 1 second) of the riding record d1.

TABLE 1
Riding parameter

| | |
|---|---|
| Recording time | YYYY/MM/DD 08:25:51 |
| Accumulated mileage | A1 m |
| Max power ratio percentage | A2% |
| Assist ratio percentage | A3% |
| Riding speed | A4 m/s |
| Pedaling frequency | A5 RPM |
| Pedaling torque | A6 mNm |
| Pedaling power | A7 Watt |
| Motor current | A8 mA |
| Motor voltage | A9 mV |
| Battery power | A10% |
| GPS position | (Longitude, Latitude) |

That is, when the rider actually rides the electric assisted bicycle 300, the electric assisted bicycle 300 may regularly report pedaling data of the rider, the motor parameters of the motor 314, and the GPS position to the server device 100.

In step S320, the server device 100 records the control commands issued by the rider while the electric assisted bicycle 300 travels through the route. Specifically, the processor 210 of the electronic device 200 may receive the control commands issued by the rider by the input device 240. Alternatively, the processor 311 of the electric assisted bicycle 300 may receive the control command issued by the rider by the input device 317. In response to receiving the control command issued by the rider, the processor 210 and/or the processor 311 may record the command content and the command issuance time of the control command to generate a control command record d2, and upload the control command record d2 to the server device 100.

In some embodiments, the control command may include a power-assisted adjustment command or a riding mode setting command. For example, the rider may press the power-assisted adjustment button (for example, a power-assisted increasing button or a power-assisted decreasing button) while riding the electric assisted bicycle 300 to issue the command for adjusting the power assist. The processor 311 may record the pressing time and the power-assisted amplitude of the power-assisted adjustment button to generate the control command record d2. Alternatively, the rider may set the electric assisted bicycle 300 to a specific riding mode (such as a power saving mode or a time saving mode) and issue the riding mode setting command. The processor 210 or the processor 311 may record each time the rider turns on the riding mode setting command of the specific riding mode to generate the control command record d2. That is, the control command record d2 may represent the control behavior of the rider riding the electric assisted bicycle 300.

In some embodiments, when the rider sets the electric assisted bicycle 300 to the power saving mode, the electric assisted bicycle 300 reduces the power assist to improve battery life. When the rider sets the electric assisted bicycle 300 to the time saving mode, the electric assisted bicycle 300 increases the power assist to speed up the riding speed.

In step S330, the server device 100 analyzes the riding record d1 to obtain the riding summary data rs1 of multiple route sections. Specifically, after the server device 100 receives the riding record d1, a data pre-processing module 41 of the server device 100 may perform data pre-processing (for example, data compression or data filtering) on the riding record d1 to obtain the riding summary data rs1 corresponding to the route sections. That is, the server device 100 may convert the riding records d1 corresponding to the sampling time points into the riding summary data rs1 of the route sections.

In some embodiments, the server device 100 divides the riding parameters corresponding to the sampling time points into multiple sampling data groups based on a length of the route section. The sampling data groups respectively correspond to the route sections. The server device 100 performs statistical operation on the riding parameters of each sampling data group to obtain the riding summary data rs1 of each route section. For example, the length of the route section may be 200 meters, but is not limited thereto. The statistical operation is, for example, average operation, but is not limited thereto. From another point of view, the server device 100 divides the route into the route sections. Specifically, the server device 100 may divide the historical traveled route into the road sections according to the length of the route section, that is, the path distance of these route sections is the same. The server device 100 may count the riding parameters corresponding to each route section to obtain the riding summary information rs1 of each route section.

In some embodiments, the server device 100 calculates the slope data of each route section according to multiple GPS positions of each sampling data group. Specifically, the server device 100 may calculate the slope data of each route section according to the GPS positions of each route section. The server device 100 may obtain multiple corresponding altitudes according to a GPS starting position and a GPS ending position of a certain route section, and calculate the slope data of the route section according to these altitudes.

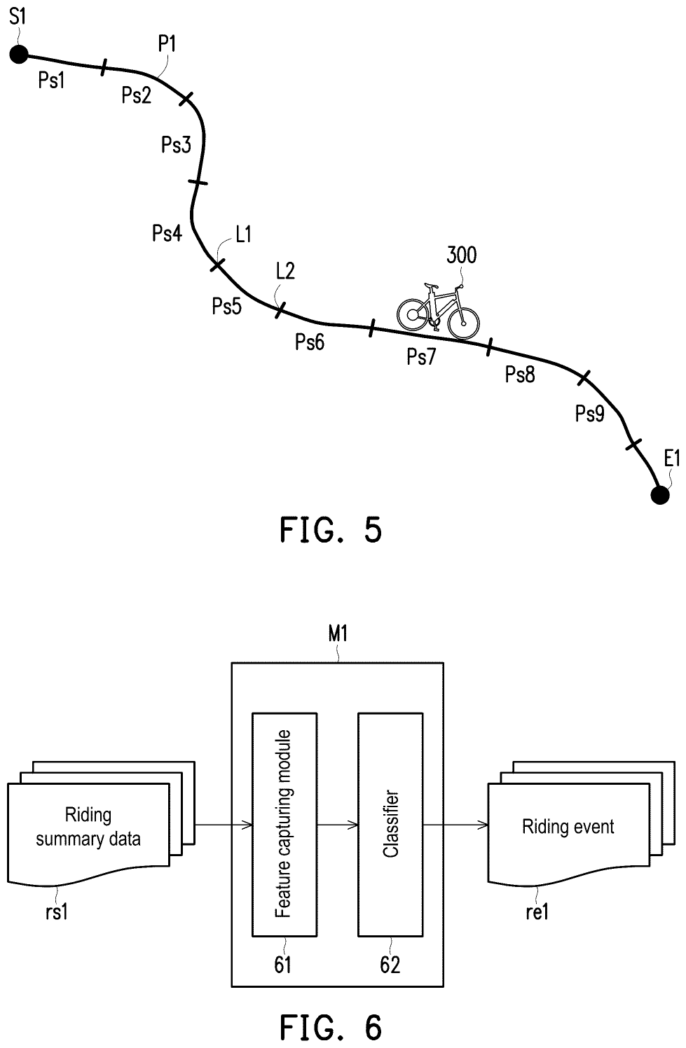

For example, FIG. 5 is a schematic diagram of multiple route sections according to an embodiment of the disclosure. Referring to FIG. 5, after the electric assisted bicycle 300 travels along a route P1 between a starting point S1 and an ending point E1, the server device 100 may collect the riding record d1 of the route P1. The riding record d1 of the route P1 includes the riding parameters corresponding to the sampling time points. The server device 100 may divide the route P1 into multiple route sections Ps1 to Ps9 according to the length of the route section. Specifically, the server device 100 may divide the riding parameters corresponding to the sampling time points into the sampling data groups respectively corresponding to the route sections Ps1 to Ps9 according to the length of the route section. Therefore, the server device 100 may average the riding parameters in a sampling data group corresponding to the route section Ps1 to obtain the riding summary data rs1 of the route section Ps1. Next, the server device 100 may average the riding parameters in another sampling data group corresponding to the route section Ps2 to obtain the riding summary data rs1 of the route section Ps2, and so on.

In addition, referring to FIG. 5, the server device 100 may calculate the slope data of each route section from Ps1 to Ps9 according to the altitude corresponding to the GPS starting position and the GPS ending position of each route section from Ps1 to Ps9. For example, the server device 100 may calculate the slope data of the route section Ps2 according to the altitude corresponding to a GPS starting position L1 and a GPS ending position L2 of the route section Ps2.

For example, based on the riding parameters of the riding record d1 in Table 1, the riding summary data rs1 corresponding to each route section is shown in Table 2. For example, the server device 100 may perform an average calculation to obtain the average riding speed in the riding summary data rs1 of the route section Ps2 according to multiple riding speeds corresponding to the route section Ps2. That is, taking FIG. 5 as an example, each route section from Ps1 to Ps9 has the riding summary data rs1 as shown in Table 2 below.

TABLE 2
Riding summary data

| | |
|---|---|
| Time | YYYY/MM/DD 09:30:00 |
| Riding mileage | B1 m |
| Max power ratio percentage | B2% |
| Assist ratio percentage | B3% |
| Average riding speed | B4 m/s |
| Average pedaling frequency | B5 RPM |
| Average pedaling torque | B6 mNm |
| Average pedaling power | B7 Watt |
| Average slope | B8% |
| Total | B9 m |

In step S340, the server device 100 updates the first power-assisted control parameter RP1 to a second power-assisted control parameter RP2 according to the control command and the riding summary data rs1 of the route sections, so that the rider rides the electric assisted bicycle 300 to travel along another route according to the updated second power-assisted control parameter RP2. As shown in FIG. 4, a riding event determination module 42 of the server device 100 detects a riding event re1 according to the riding summary data rs1 of the route sections. Therefore, a power-assisted parameter personalized adjustment module 43 of the server device 100 may adjust the first power-assisted control parameter RP1 to generate the second power-assisted control parameter RP2 according to the riding event re1 and the control command record d2.

In some embodiments, after generating the second power-assisted control parameter RP2, the server device 100 transmits the second power-assisted control parameter RP2 to the processor 311, so that the processor 311 may replace the first power-assisted control parameter RP1 originally recorded by the storage device 315 with the second power-assisted control parameter RP2. Therefore, next time the rider rides the electric assisted bicycle 300 to travel along another route, the processor 311 and the motor controller 313 control the motor output of the motor 314 according to the updated second power-assisted control parameter RP2.

That is, the power-assisted control parameters applied to the electric assisted bicycle 300 are updated to be closer to the actual needs of the rider according to the riding record generated by the rider each time. Therefore, as riding times increase, the power-assisted control parameters applied to the electric assisted bicycle 300 may be customized to be unique to the rider, so that the rider no longer needs to frequently manually adjust the power-assist level of the electric assisted bicycle 300.

In some embodiments, the server device 100 may determine whether the riding event re1 occurs according to the riding summary data rs1 of the route sections. In some embodiments, the server device 100 may adjust the first power-assisted control parameter RP1 to generate the second power-assisted control parameter RP2 according to the riding event re1 and a first adjustment amplitude in a case of determining that the riding event re1 occurs. The first adjustment amplitude may be a first preset proportion value or a first preset value. The server device 100 may multiply the first power-assisted control parameter RP1 by the first preset proportion value to generate the second power-assisted control parameter RP2. The server device 100 may add or subtract the first preset value to/from the first power-assisted control parameter RP1 to generate the second power-assisted control parameter RP2.

In some embodiments, the server device 100 may input the riding summary data rs1 of the route sections into a machine learning model to output the occurrence probability of at least one riding event re1. The server device 100 may compare the occurrence probability of the at least one riding event re1 with a threshold value to determine whether the riding event re1 occurs. In some embodiments, the server device 100 may compare the riding summary data rs1 of the route sections with a preset threshold value to determine whether the riding event re1 occurs. For example, the server device 100 may compare the average riding speed of the route sections with the preset threshold value to determine whether a recent change in the riding speed of the riding event has occurred.

In some embodiments, the aforementioned riding event re1 may include the recent change in the riding speed, a recent change in a riding route, or a recent change in riding mileage. When the server device 100 determines that the recent change in the riding route of the riding event occurs, the riding speed of the electric assisted bicycle 300 that the rider recently rode has decreased or increased. When the server device 100 determines that the recent change in the riding mileage of the riding event has occurred, the riding slope of the electric assisted bicycle 300 that the rider recently rode has become steeper or slower. When the server device 100 determines that the recent change in the riding mileage of the riding event occurs, the riding distance of the electric assisted bicycle 300 that the rider recently rode has become longer or shorter.

FIG. 6 is a schematic diagram of determining a riding event according to an embodiment of the disclosure. Referring to FIG. 6, the server device 100 may input the riding summary data rs1 of the route sections into a machine learning model M1. The machine learning model M1 is, for example, a neural network model or a support vector machine model, and so on. The machine learning model M1 may be established according to the training data and a machine learning algorithm. Model parameters of the trained machine learning model may be recorded in the storage device 120 of the server device 100. The machine learning model M1 may include a feature capturing module 61 and a classifier 62. The riding summary data rs1 of the route sections are fed into the feature capturing module 61 to generate multiple feature data. The classifier 62 may output the occurrence probability of one or multiple riding events re1 according to the feature data generated by the feature capturing module 61. Therefore, when the occurrence probability of the riding event re1 is higher than the threshold value, a case that the riding event re1 occurs is determined. When the occurrence probability of the riding event re1 is not higher than the threshold value, a case that the riding event re1 has not occurred is determined. It should be noted that the training data of the machine learning model M1 may be generated by collecting multiple test riders who actually ride electric assisted bicycles to travel along multiple test paths, and the training data may include the riding records of the test riders.

In some embodiments, the server device 100 may adjust the first power-assisted control parameter RP1 to generate the second power-assisted control parameter RP2 according to the reception state of the control command and a second adjustment amplitude. That is, the server device 100 may adjust the first power-assisted control parameter RP1 to generate the second power-assisted control parameter RP2 according to the control command record d2 and the second adjustment amplitude. The second adjustment amplitude may be a second preset proportion value or a second preset value. The server device 100 may multiply the first power-assisted control parameter RP1 by the second preset proportion value to generate the second power-assisted control parameter RP2. The server device 100 may add or subtract the second preset value to/from the first power-assisted control parameter RP1 to generate the second power-assisted control parameter RP2.

In some embodiments, the first power-assisted control parameter RP1 may include a first MAP and a first ARP. The second power-assisted control parameter RP2 may include a second MAP and a second ARP. The server device 100 may adjust the first MAP to generate the second MAP. The server device 100 may adjust the first ARP to generate the second ARP.

In some embodiments, when the server device 100 determines that the rider presses the power-assisted increasing button (that is, issuing the power-assisted adjustment command) during the riding process according to the control command record d2, the server device 100 may adjust the first MAP or the first ARP. Specifically, in response to the rider pressing the power-assisted increasing button during the riding process, if the server device 100 determines that a difference between the power assist currently obtained by the rider and the first MAP is less than the threshold value, the server device 100 may increase the first MAP. Otherwise, if the server device 100 determines that the difference between the power assist currently obtained by the rider and the first MAP is not less than the threshold value, the server device 100 may increase the first ARP.

In some embodiments, when the server device 100 determines that the rider presses the power-assisted decreasing button (that is, issuing the power-assisted adjustment command) during the riding process according to the control command record d2, the server device 100 may adjust the first MAP or the first ARP. Specifically, in response to the rider pressing the power-assisted decreasing button during the riding process, if the server device 100 determines that a difference between the power assist currently obtained by the rider and the first MAP is less than the threshold value, the server device 100 may lower the first MAP. Otherwise, if the server device 100 determines that the difference between the power assist currently obtained by the rider and the first MAP is not less than the threshold value, the server device 100 may lower the first ARP.

In some embodiments, the server device 100 may adjust the first power-assisted control parameter RP1 according to the reception state of the riding mode setting command of the control command record d2, such as reception times within a preset period. According to the reception times of the riding mode setting command within the preset period, the server device 100 may obtain the recent activation frequency of the specific riding mode.

In some embodiments, when the server device 100 determines that the recent activation frequency of the power saving mode is higher than the threshold value according to the control command record d2, the server device 100 may simultaneously lower the first MAP or the first ARP. When the server device 100 determines that the recent activation frequency of the time saving mode is higher than the threshold value according to the control command record d2, the server device 100 may simultaneously increase the first MAP or the first ARP.

In some embodiments, when the server device 100 determines that the recent riding speed becoming faster of the riding event occurs, the server device 100 may lower the first ARP. When the server device 100 determines that the recent riding speed slowing down of the riding event occurs, the server device 100 may increase the first ARP.

In some embodiments, when the server device 100 determines that the recent riding route becoming steeper of the riding event occurs, the server device 100 may simultaneously increase the first MAP or the first ARP. When the server device 100 determines that the recent riding route becoming slower of the riding event occurs, the server device 100 may simultaneously lower the first MAP or the first ARP.

In some embodiments, when the server device 100 determines that the recent riding mileage becoming longer of the riding event occurs, the server device 100 may increase the first ARP. When the server device 100 determines that the recent riding mileage becoming shorter the riding event occurs, the server device 100 may lower the first ARP.

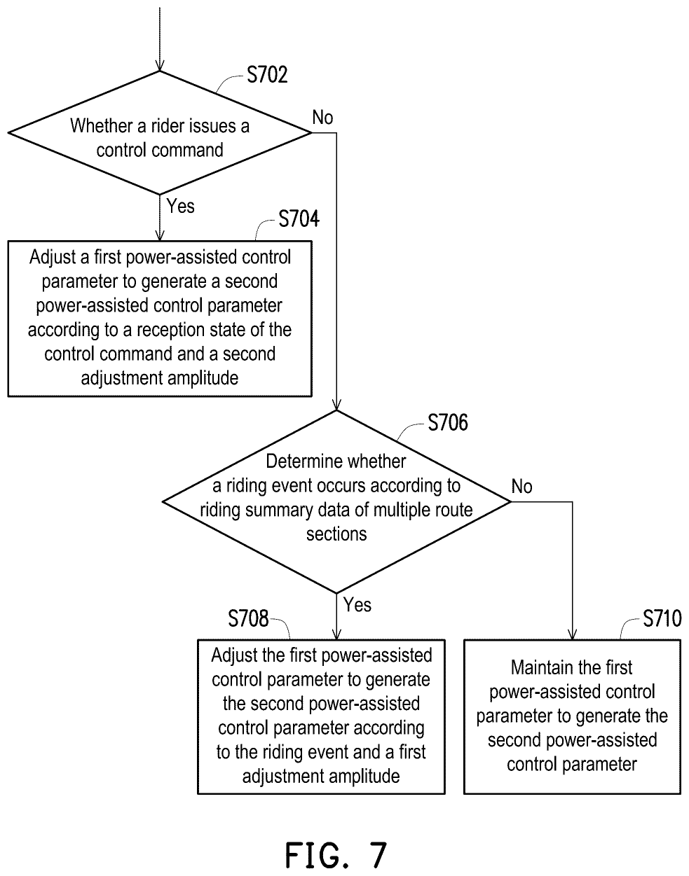

FIG. 7 is a flowchart of updating a first power-assisted control parameter to a second power-assisted control parameter according to an embodiment of the disclosure. Please refer to FIG. 7. In step S702, the server device 100 determines whether the rider issues the control command during the riding process. If the determination in step S702 is yes, in step S704, the server device 100 adjusts the first power-assisted control parameter to generate the second power-assisted control parameter according to the reception state of the control command and the second adjustment amplitude. If the determination in step S702 is no, in step S706, the server device 100 determines whether the riding event occurs according to the riding summary data of the route sections. If the determination in step S706 is yes, the server device 100 adjusts the first power-assisted control parameter to generate the second power-assisted control parameter according to the riding event and the first adjustment amplitude. If the determination in step S706 is no, the server device 100 maintains the first power-assisted control parameter to generate the second power-assisted control parameter. It should be noted that in some embodiments, the first adjustment amplitude may be larger than the second adjustment amplitude. In this way, the server device 100 accelerates and adjusts the power-assisted control parameters to a state that meets the needs of the rider according to the feedback control of the rider. In addition, the server device 100 may make gentle adjustments to the power-assisted control parameters according to a change in a riding habit of the rider.

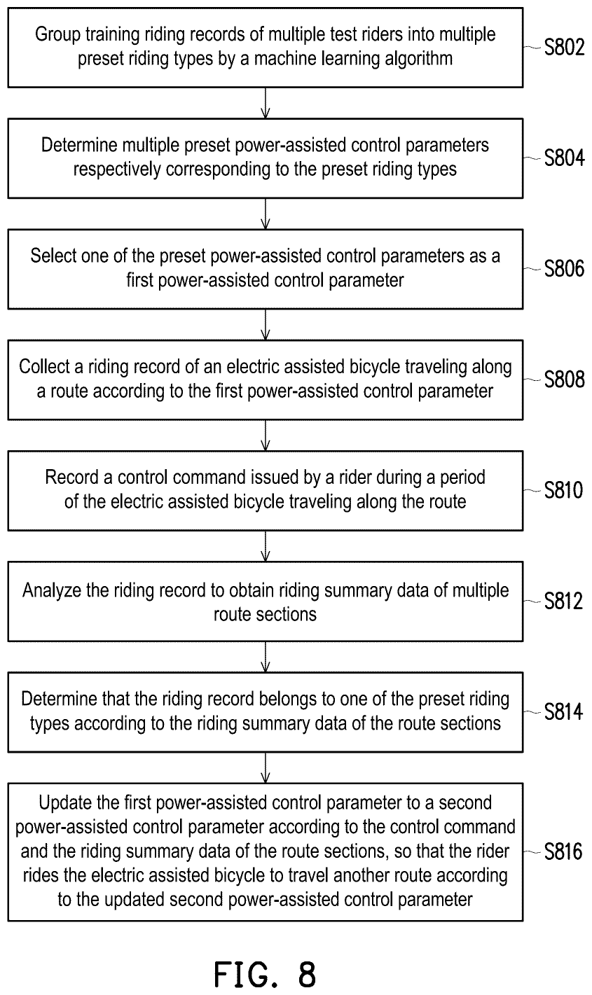

FIG. 8 is a flowchart of a method for adjusting power assist of an electric assisted bicycle according to an embodiment of the disclosure. A description of the steps of the method for adjusting the power assist of the electric assisted bicycle according to this embodiment with reference to the elements in FIG. 1 and FIG. 2 is as follows.

In step S802, the server device 100 groups the training riding records of the test riders into multiple preset riding types by the machine learning algorithm. The machine learning algorithm is a clustering algorithm. For example, the clustering algorithm may be a K-means clustering algorithm or other algorithms. The K-means clustering algorithm is an unsupervised learning algorithm which may divide a group of data into n data clusters. The disclosure does not limit the number (that is, the number of clusters) of preset riding types.

In some embodiments, the server device 100 may also perform data pre-processing on the training riding records of the test riders, and convert the training riding records of the test riders into the riding summary data corresponding to the route sections. The server device 100 may group the riding summary data of the test riders into multiple data clusters to generate the preset riding types corresponding to the data clusters one by one.

In step S804, the server device 100 determines multiple preset power-assisted control parameters respectively corresponding to the preset riding types. Specifically, after grouping the training riding records of the test riders into the preset riding types, the server device 100 may dispose the preset power-assisted control parameters of each preset riding type. The preset power-assisted control parameters may include a preset MAP, a preset ARP, or a preset motor control parameter.

In step S806, the server device 100 selects one of the preset power-assisted control parameters as the first power-assisted control parameter. The first power-assisted control parameter is one of the preset power-assisted control parameters. In some embodiments, the server device 100 may select the first power-assisted control parameter from the preset power-assisted control parameters according to personal information and a questionnaire provided by the rider. The server device 100 may transmit the first power-assisted control parameter to the electric assisted bicycle 300. Therefore, the electric assisted bicycle 300 provides the power assist to the rider according to the first power-assisted control parameter.

In step S808, the server device 100 collects the riding record of the electric assisted bicycle 300 traveling along the route according to the first power-assisted control parameter. In step S810, the server device 100 records the control command issued by the rider during the period of the electric assisted bicycle traveling along the route. In step S812, the server device 100 analyzes the riding record to obtain the riding summary data of the route sections. The detailed implementation of step S808 to step S812 may be referred to the descriptions of the foregoing embodiments and is not repeated herein.

In step S814, the server device 100 determines that the riding record belongs to one of the preset riding types according to the riding summary data of the route sections. In some embodiments, the server device 100 inputs the riding summary data of the route sections into the machine learning model, so that the machine learning model classifies the riding record into one of the preset riding types. Otherwise, in some embodiments, by determining whether the riding summary data of the route sections falls within a numerical range corresponding to each preset riding type, the server device 100 may classify the riding record into one of the preset riding types.

In step S816, the server device 100 updates the first power-assisted control parameter to the second power-assisted control parameter according to the preset assist control parameter of one of the preset riding types, so that the rider rides the electric assisted bicycle to travel another route according to the updated second power-assisted control parameter. Specifically, when the riding record is classified as a first preset riding type of the preset riding types, the server device 100 adjusts the first power-assisted control parameter according to the preset power-assisted control parameter of the first preset riding type. Here, the server device 100 adjusts the first power-assisted control parameter by moving the first power-assisted control parameter closer to the preset assist control parameter of the first preset riding type. For example, it is assumed that the first power-assisted control parameter is 50%, the preset power-assisted control parameter of the first preset riding type is 60%. The server device 100 may adjust the first power-assisted control parameter to generate the second power-assisted control parameter, such as 55%.

In summary, according to the embodiments of the disclosure, the power-assisted control parameters of the electric assisted bicycle may be adaptively adjusted to the state that meets the individual needs of the rider according to the riding record of the rider. In this way, the rider does not need to frequently manually adjust the power assist of the electric assisted bicycle, thereby further improving the riding experience of the electric assisted bicycle.

Although the disclosure has been disclosed in the above embodiments, the embodiments are not intended to limit the disclosure. Persons skilled in the art may make some changes and modifications without departing from the spirit and scope of the disclosure. Therefore, the protection scope of the disclosure shall be defined by the appended claims.

What is claimed is:

1. A method for adjusting a power assist of an electric assisted bicycle, comprising:
collecting a riding record of the electric assisted bicycle traveling along a route according to a first power-assisted control parameter, wherein the first power-assisted control parameter is configured to control a motor output of the electric assisted bicycle;
recording a control command issued by a rider during a period of the electric assisted bicycle traveling along the route;
analyzing the riding record to obtain riding summary data of a plurality of route sections; and
updating the first power-assisted control parameter to a second power-assisted control parameter according to the control command and the riding summary data of the plurality of route sections, so that the rider rides the electric assisted bicycle to travel another route according to the updated second power-assisted control parameter.

2. The method for adjusting the power assist of the electric assisted bicycle according to claim 1, wherein the riding record comprises a plurality of riding parameters corresponding to a plurality of sampling time points, and the step of analyzing the riding record to obtain the riding summary data of the plurality of route sections comprises:
dividing the plurality of riding parameters corresponding to the plurality of sampling time points into a plurality of sampling data groups based on a length of a route section, wherein the plurality of sampling data groups respectively correspond to the plurality of route sections; and
performing a statistical calculation on the plurality of riding parameters of each of the plurality of sampling data groups to obtain the riding summary data of each of the plurality of route sections.

3. The method for adjusting the power assist of the electric assisted bicycle according to claim 2, wherein when the electric assisted bicycle travels along the route, a sensor of the electric assisted bicycle is configured to detect the plurality of riding parameters.

4. The method for adjusting the power assist of the electric assisted bicycle according to claim 2, wherein the plurality of riding parameters comprise a plurality of GPS positions, and the step of analyzing the riding record to obtain the riding summary data of the plurality of route sections further comprises:
calculating slope data of each of the plurality of route sections according to the plurality of GPS positions of each of the plurality of sampling data groups.

5. The method for adjusting the power assist of the electric assisted bicycle according to claim 1, wherein the step of updating the first power-assisted control parameter to the second power-assisted control parameter according to the control command and the riding summary data of the plurality of route sections comprises:
determining whether a riding event occurs according to the riding summary data of the plurality of route sections; and
adjusting the first power-assisted control parameter to generate the second power-assisted control parameter according to the riding event and a first adjustment amplitude in a case of determining that the riding event occurs.

6. The method for adjusting the power assist of the electric assisted bicycle according to claim 1, wherein the control command comprises a power-assisted adjustment command or a riding mode setting command.

7. The method for adjusting the power assist of the electric assisted bicycle according to claim 1, wherein the step of updating the first power-assisted control parameter to the second power-assisted control parameter according to the control command and the riding summary data of the plurality of route sections comprises:
adjusting the first power-assisted control parameter to generate the second power-assisted control parameter according to a reception state of the control command and a second adjustment amplitude.

8. The method for adjusting the power assist of the electric assisted bicycle according to claim 1, wherein the first power-assisted control parameter comprises a max assist power, an assist ratio percentage, or a motor control parameter.

9. The method for adjusting the power assist of the electric assisted bicycle according to claim 1, further comprising:
grouping training riding records of a plurality of test riders into a plurality of preset riding types by a machine learning algorithm; and
determining a plurality of preset power-assisted control parameters respectively corresponding to the plurality of preset riding types, wherein the first power-assisted control parameter is one of the plurality of preset power-assisted control parameters.

10. The method for adjusting the power assist of the electric assisted bicycle according to claim 9, wherein the step of updating the first power-assisted control parameter to the second power-assisted control parameter according to the control command and the riding summary data of the plurality of route sections comprises:
determining that the riding record belongs to one of the plurality of preset riding types according to the riding summary data of the plurality of route sections; and
updating the first power-assisted control parameter to the second power-assisted control parameter according to a preset power-assisted control parameter of one of the plurality of preset riding types.

11. A system for adjusting a power assist of an electric assisted bicycle, comprising:
a storage device;
a processor, coupled to the storage device and configured to:
collect a riding record of the electric assisted bicycle traveling along a route according to a first power-assisted control parameter, wherein the first power-assisted control parameter is configured to control a motor output of the electric assisted bicycle;
record a control command issued by a rider during a period of the electric assisted bicycle traveling along the route;
analyze the riding record to obtain riding summary data of a plurality of route sections; and
update the first power-assisted control parameter to a second power-assisted control parameter according to the control command and the riding summary data of the plurality of route sections, so that the rider rides the electric assisted bicycle to travel another route according to the updated second power-assisted control parameter.
